(19) United States
(12) Patent Application Publication
(10) Pub. No.: US 2017/0264598 A1
(43) Pub. Date: Sep. 14, 2017

(54) METHOD AND APPARATUS FOR PERFORMING SYMMETRICAL STREAM ENCRYPTION OF DATA

(71) Applicant: Rene-Michael CORDES, Mannsworth (AT)

(72) Inventor: Rene-Michael CORDES, Mannsworth (AT)

(21) Appl. No.: 13/991,389

(22) PCT Filed: Dec. 1, 2011
(86) PCT No.: PCT/AT11/00483

§ 371 Date: Aug. 20, 2013

(30) Foreign Application Priority Data
Dec. 2, 2010 (AT) A 2007/2010

(51) Int. Cl. H04L 29/06; H04L 9/06

(52) U.S. Cl. CPC H04L 63/0457; H04L 63/0435; H04L 9/0668; H04L 2209/12; G06F 7/584

(57) ABSTRACT

In a method for performing symmetric stream encryption of data using a keystream and for transmitting the encrypted data, wherein the keystream is generated using at least one feedback shift register, which is initialized by filling with a defined bit sequence, the data to be encrypted is distributed into data packets, wherein each data packet is encrypted separately. The one or more feedback shift register(s) is/are re-initialized in order to encrypt each data packet, wherein at least a first bit sequence and a second bit sequence are used in each case to initialize the one or more feedback shift registers, wherein the first bit sequence is added to each encrypted data packet in clear text or in coded form and the second bit sequence represents a secret key that is not added to the encrypted data packets. The encrypted data packets are transmitted in packet switching mode together with the respectively added bit sequence and optionally header data.

The invention relates to a method for performing symmetric stream encryption of data using a keystream and for transmitting the encrypted data, wherein the keystream is generated using at least one feedback shift register, which is filled with a defined bit sequence to initialize it.

The invention further relates to a corresponding method for decrypting data that has been encrypted using symmetric stream encryption.

The invention further relates to a device for encrypting data by symmetric stream encryption using a keystream, wherein at least one feedback shift register that is initialized each time by filling with a defined bit sequence is provided to generate the keystream. The invention further relates to a device for decrypting data that has been encrypted using symmetric stream encryption.

Stream encryption is the term used for a cryptographic algorithm in which plain text characters are combined individually with the characters of a keystream. In the case of stream encryption of digital data—when only the symbols 0 and 1 are used—the plain text stream is combined with the keystream using the XOR function. The keystream is a pseudo-random character string. Most stream ciphers use a symmetric key. The key determines the initial state of the system.

As a rule, at least one feedback shift register is used to generate the keystream. Linear feedback shift registers can be implemented efficiently either directly in hardware such as FPGAs, or in software. Feedback shift registers are fast and produce pseudo-random sequences with good statistical properties. A feedback shift register in digital equipment has the form of a shift register with n storage elements. The individual storage elements are typically D flip-flops, which can each store one bit. Unlike a conventional shift register, there are branches between certain D flip-flops, which represent the back coupling. Usually, one XOR function is used for each back coupling. However, an XNOR operation can also be used instead of the XOR operation.

To initialize, the shift register may be filled with XOR back coupling having any values, which determine the keystream generated subsequently by the shift register. Like any other shift register, the feedback shift register also has a clock input: A change is made to the next state at each clock pulse, that is to say when a bit is to be output all the bits in the shift register are shifted by one storage location; the new bit at the end of the shift register is calculated on the basis of the other bits. This process counts like a clock. 2ⁿ⁻¹ clock pulses are necessary to make a complete cycle through all combinations. Such a code sequence thus has a length of 2ⁿ⁻¹ bits (n=number of code generating, serially connected storage elements in the shift register). The keystream generator is usually formed by a number of linear feedback shift registers, which are usually of different lengths and have different feedback polynomials. In this way, linear feedback shift registers can be combined to create nonlinear generators.

The greater the length of the code sequence for the keystream or the code, the more difficult it is to decrypt. For example, an infinite code would not even need to be encrypted, as it is never fully known. Functionally, any code that does no repeat before the end of the information to be encrypted may be considered infinite. A functionally infinite code has the disadvantage that it cannot be transmitted; it must be generated.

One disadvantage of code generators in the form of conventional feedback shift registers is the fact that the structure of the generator can easily be deduced from the code sequence, so that it can be regenerated with a similarly constructed generator. A significant improvement in this respect is achieved with the code generator known from WO 03/075507 A1.

Another drawback of conventional data stream encryption is the fact that it can only be used in packet-switched data transmission (for example on the Internet via the IP protocol) if the encryption security level is reduced. In packet-switched data transmission, each data packet must be encrypted separately and the key used for the encryption of each data packet must be known at the receiving end for decryption, so that decryption still remains possible even if individual data packets are lost, arrive at the receiver twice or take different paths or packets are fragmented upon arrival at the receiver. The simplest way to ensure that data is assigned unambiguously to the key or keystream even given the malfunctions described above is to use the same key-stream for each data packet. However, this also makes it easier to break the encryption.

The present invention therefore aims to provide a method and device for encrypting and/or decrypting data using stream encryption or decryption, wherein the encrypted data must be present in packets of any desired size, so that it is suitable for simultaneous transmission of high frequency binary data streams for long periods of time in packet data networks. The encryption must be as secure as possible, and the encryption should be rendered all but impossible to break.

To solve this task, according to a first aspect of the invention the encryption method of the type described at the outset is advanced in such manner that the data to be encrypted is divided into data packets, that each data packet is encrypted separately, wherein the one or more feedback shift register(s) is/are re-initialized for the encryption of each data packet, wherein at least one first bit sequence and a second bit sequence is used to initialize each of the one or more feedback shift register(s), wherein the first bit sequence is added to the respectively encrypted data packet in clear text or in coded form and the second bit sequence represents a secret key that is not added to the encrypted data packets, and that the encrypted data packets are transmitted in packet-switched mode together with the respective added bit sequence and header data as necessary.

In order to decrypt the data packets, according to a second aspect of the invention it is provided that the data to be decrypted is received as data packets, that each received data packet is decrypted separately, wherein the one or more feedback shift register(s) is/are re-initialized for the decryption of each data packet, wherein at least one first bit sequence and a second bit sequence is used to initialize each of the one or more feedback shift register(s), wherein the first bit sequence is read out of the respective data packet to be decrypted in clear text or in coded form and the second bit sequence represents a secret key that cannot be read out from the data packets that are to be decrypted.

Thus, according to the invention all of the information necessary for decrypting each individual data packet except the secret key is incorporated in each packet, so that the communication partners only have to exchange the secret key or the information required to generate the secret key before the data is transmitted. Since according to the invention each data packet contains the first bit sequence that was used for encrypting the corresponding data packet in plain text or in coded form, this first bit sequence can be read out of the respective data packet by the receiver and used for the decryption. This makes it possible to encrypt each data packet with a different key, thereby making it more difficult to break the encryption. If, as is reflected in a preferred method, a unique bit sequence that is added in plain text or encoded form to the respective encrypted data packet as a packet identifier is selected as the first bit sequence, it is ensured that two data packets with the same plain text content are not also encrypted identically, that is to say the encrypted data packets differ from one another. This in turns makes it more difficult to obtain any reference points regarding the transmitted characters by carrying out a statistical analysis of the data packets.

The second bit sequence, that is to say the secret key, is preferably generated from a unique identifier of the transmitter and/or a unique identifier of the receiver. In this context, for example, a hardware identifier of the transmitter and a hardware identifier of the receiver, particularly a chip number or similar engraved by the manufacturer, may be used as the unique identifier. The second bit sequence is preferably generated by linking the unique identifier of the sender and the unique identifier of the receiver using an XOR function. This requires that the transmitters and receivers exchange their identifiers before the data is transmitted.

As was noted previously, the first and the second bit sequences are used in the encryption and decryption process to initialize the one or more feedback shift register(s). This is done particularly when only a single feedback shift register is used to generate the keystream, in such manner that the first and second bit sequences are linked via an XOR function and the bit sequence resulting from the operation is transferred to the feedback shift register to initialize it. Alternatively, and particularly when at least two interconnected feedback shift registers are used to generate the keystream, the procedure is such that at least a first feedback shift register is filled with the first bit sequence for initialization thereof and at least a second feedback shift register is filled with the second bit sequence for initialization thereof. This approach makes it more difficult to determine the structure of the keystream generator and/or the secret key on the basis of the first bit sequence, which is transmitted at the same time.

A higher degree of security is achieved if, as is reflected in a further preferred method, a third bit sequence is used to initialize the one or more feedback shift register(s). In this case, the third bit sequence is advantageously generated from a current date and/or time record. The third bit stream is preferably transferred to a third feedback shift register to initialize it.

Another advantage of the method according to the invention is that the generation of the keystream may begin as soon as at least one of the feedback shift registers is filled with the first bit from the respective bit sequence. In particular, the feedback shift registers are filled with the respective bit sequences simultaneously.

The structure of the keystream generator is such that, as is known per se, at least one XOR gate is used for back coupling the one or more shift register(s). As a consequence, this enables the complexity of the generator to be increased simply by connecting the back coupled feedback shift registers to one another in such manner that depending on the state of the one shift register the at least one XOR gate of the other shift register is switched on or off.

An especially preferred variant is enabled with the use of a code generator such as is described in WO 03/075507 A1, wherein explicit reference is made to claims 15, 16 and 31 to 36 of the present application. With an encryption code generator of such kind, the encryption cannot be broken even if both the structure of the code generator and the algorithm running in it are known. The generator is structured in such a way that it is able to generate so many different codes of such great length that the probability that the code currently being used as well as the location currently being produced in the code may be discovered is infinitesimally small. The code then cannot be regenerated if the generator is able to create so many different codes, that it is not possible to predict the continuation thereof from a portion of the single code.

According to a further aspect of the present invention, one encryption device and one decryption device are suggested.

The device according to the invention for encrypting data by symmetric stream encryption using a key stream, wherein at least one back feedback shift register that is initialized each time by filling with a defined bit sequence is provided to generate the keystream, is characterized in that the data present is distributed in data packets, that means are provided for generating and/or storing at least a first bit sequence and a second bit sequence and cooperate with the one or more shift register(s) in such a manner that at least the first bit sequence and the second bit sequence are used to initialize the one or more feedback shift register(s), the one or more or feedback shift register(s) is/are re-initialized for encrypting each data packet, that data packet processing means are provided with which the means for generating and storing said first and second bit sequences cooperate in such that the first bit sequence is added to the respective encrypted data packet in clear text or in coded form and the second bit sequence represents a secret key and is not added to the encrypted data packets, and that data transmission means are provided for packet-switched sending of the encrypted data packets together with the respective added bit sequence and optional header data.

The device according to the invention for decrypting data that has been encrypted by symmetric stream encryption using a keystream, wherein at least one feedback shift register that is initialized in each case by filling with a defined bit sequence is provided to generate the keystream, is characterized in that the encrypted data is present and distributed in data packets, that means for reading out a first bit sequence in plain text or in coded form from the data packets and means are provided for generating and/or storing at least a second bit sequence, which means cooperate with the one or more shift register(s) in such a manner that at least the first bit sequence and the second bit sequence are used to initialize the one or more feedback shift register(s), wherein the one or more feedback shift register(s) is/are re-initialized for the decryption of each data packet, wherein the second bit sequence is a secret key that cannot be read out from the encrypted data packets.

Preferred refinements are defined in the dependent claims.

In the following, the invention will be explained in greater detail with reference to the exemplary embodiments illustrated schematically in the drawing. In the drawing,

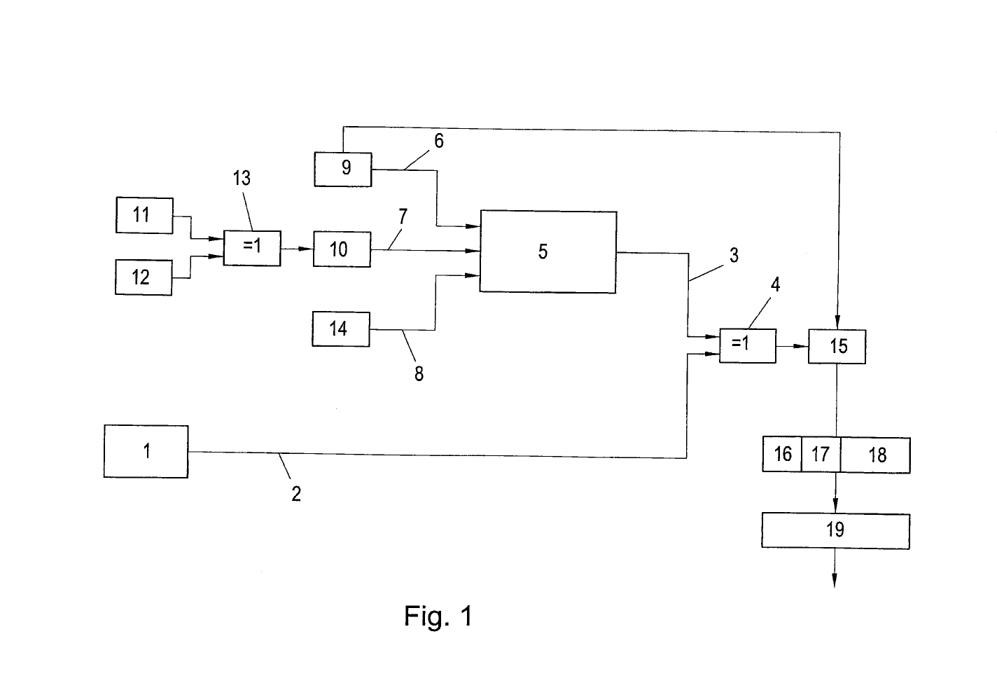

FIG. 1 shows an encryption device according to the invention,

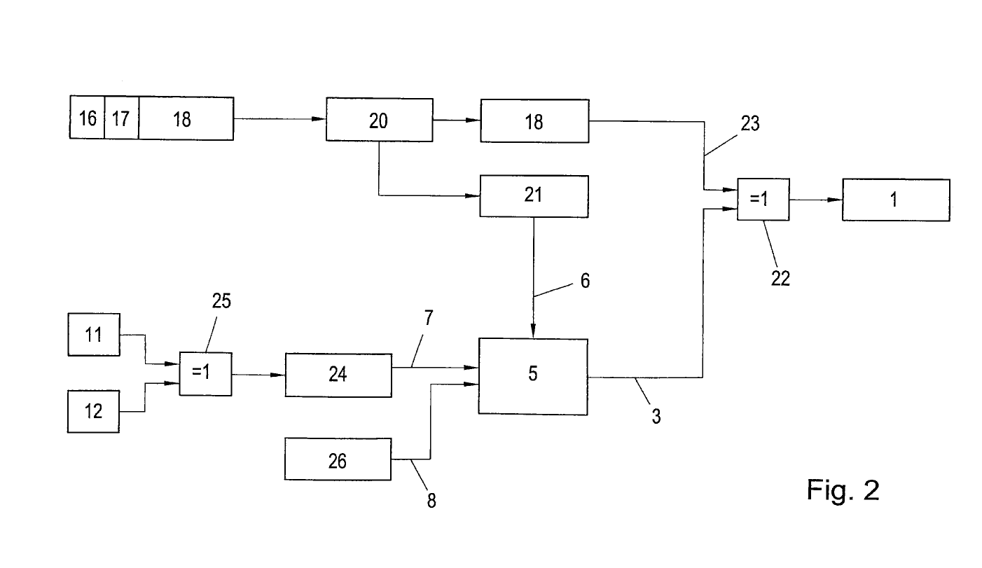

FIG. 2 shows a decryption device according to the invention,

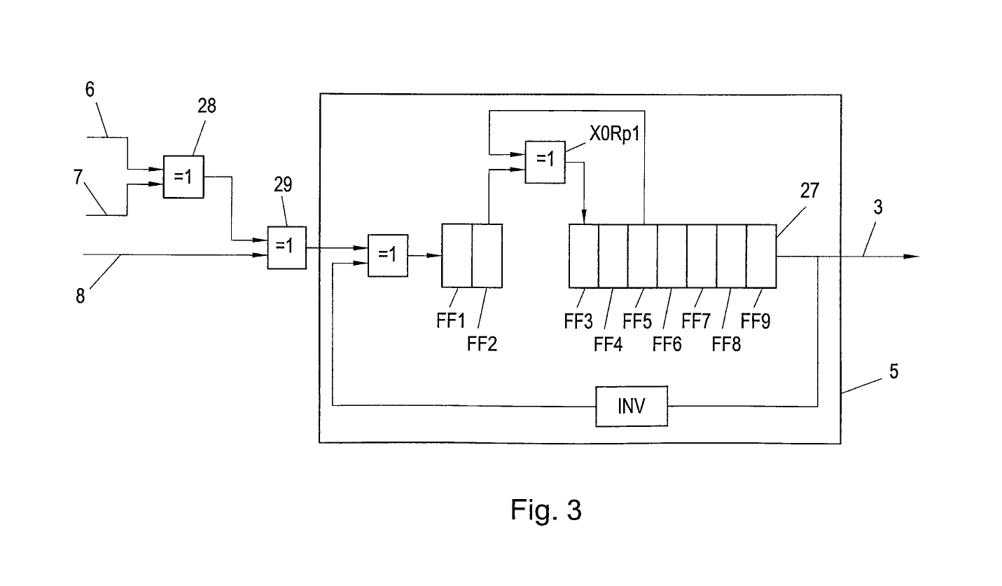

FIGS. 3, 4, 5 and 6 show various designs of a key stream generator used in the device.

FIG. 1 shows a data packet to be encrypted, designated with 1, wherein data packet 1 comprises a plurality of bits in plain text. The encryption is generally carried out in such a manner that the bits of bit stream 2 of the plain text are combined individually with the bits of a keystream 3 with the aid of an XOR gate 4. A code generator 5 is used to generate keystream 3 and will be described in greater detail with reference to FIGS. 3 to 6. Code generator 5 generates the keystream on the basis of a plurality of bit sequences 6, 7 and 8, which are supplied to code generator 5 as a key. A first bit sequence 6 is stored in a memory 9 and represents a unique identifier of data packet 1 that is to be encrypted. In this context, uniqueness must be assured at least within the total number of data packets that are to be transmitted continuously. The length of the first bit sequence is thus at least log (N;2) bits (N=total number of transmitted packets). Second bit sequence 7 is stored in a memory 10 and is generated from a unique identifier 11 of the transmitter and a unique identifier 12 of the receiver. In this context, second bit sequence 7 is generated in that the bits of unique identifier 11 and the bits of unique identifier 12 are linked together with the aid of an XOR gate 13. The use of second bit sequence 7 as the key for generating keystream 3 ensures that only the receiver, to which unique identifiers 11 and 12 must also be known, is able to decrypt the encrypted data packets. Third bit sequence 8 is stored in a memory 14 or is generated there, on the basis of a current date or time indicator. Bit sequence 8 may correspond to the current date, for example. Consequently, keystream 3 has a completely different structure every day, thereby making it more difficult to break the encryption.

The encrypted data of the data packet is now forwarded to data packet processing means 15, with which memory 9 for first bit sequence 6 cooperated in such a manner that first bit sequence 6 is added to the encrypted data packet in clear text. On the other hand, second bit sequence 7 and third bit sequence 8, are not added to the encrypted data packet, but are known at the receiver in any case. Data packet processing means 15 further ensure that the encrypted data packet is provided with the usual header data that is needed for packet-switched transmission in a computer network. Accordingly, when ready for sending the data packet thus consists of header data 16, the first bit sequence as packet identifier 17 and encrypted payload 18. The packet-switched data transmission means for sending the data packet are designated by 19.

The device for decrypting the encrypted data packets shown in FIG. 2 is structured in substantially the same way. The packet containing header data 16, the first bit sequence as packet identifier 17 and the encrypted payload 18 is passed upon arrival to readout means 20, in which second bit sequence 17 is read out and forwarded to a memory 21. The encrypted payload data 18 is then routed to an XOR gate 22, in which the bits of coded bitstream 23 and the bits of keystream 3 are combined with one another in order to obtain decrypted data packet 1.

Keystream 3 that is used to decrypt a specific packet of data must be the same as the keystream that was used to encrypt the same data packet. For this purpose, the same bit sequences 6, 7 and 8 are routed to generator 5 as the key and generator 5 that is used for decryption is of the same construction as the generator 5 used for the encryption. The memory for second bit sequence 7 is designated with 24. Linked transmitter and receiver identifiers 11 and 12 are routed to memory 24 via the XOR gate 25. Third bit sequence 8 is stored in memory 26 and/or is generated there.

FIG. 3 shows a circuit diagram of a keystream generator 5 with a shift register 27 that consists of a plurality of storage elements, specifically flip-flops FF1, FF2, . . . FF9 that are connected together to form a code-producing series. An XOR gate XORp1 is connected such that the one input of XOR gate XORp1 is connected to the output of storage element FF2 located in the code-producing series, and the other input of XOR gate XORp1 is connected to the output of storage element FF5 located in the code-producing series, and the output of the XOR gate XORp1 is connected to the input of the storage element FF3 that follows downstream—and thus recursively—after storage element FF2 which is connected to the one input of XOR gate XORp1. This figure also shows that the last storage element of FF9 is connected to the first storage element FF1 via an inverter INV. As soon as shift register 27 is filled with a bit sequence, this circuit returns a code sequence. If, as is the case in the embodiment according to FIG. 3, only a single shift register is used, bit sequences 6, 7 and 8 are routed to shift register 27 in such manner that bit sequences 6 and 7 are first combined with the aid of an XOR gate 28, and then the combined bit sequence is combined with bit sequence 8 by means of XOR gate 29. In this context it is preferable that the bit sequence generated from bit sequences 6, 7 and 8, which is transferred to shift register 27, is not longer than the number of storage elements in shift register 27, otherwise the bit sequence would be overlapped by the bit sequence coming from storage elements FF9 through inverter INV.

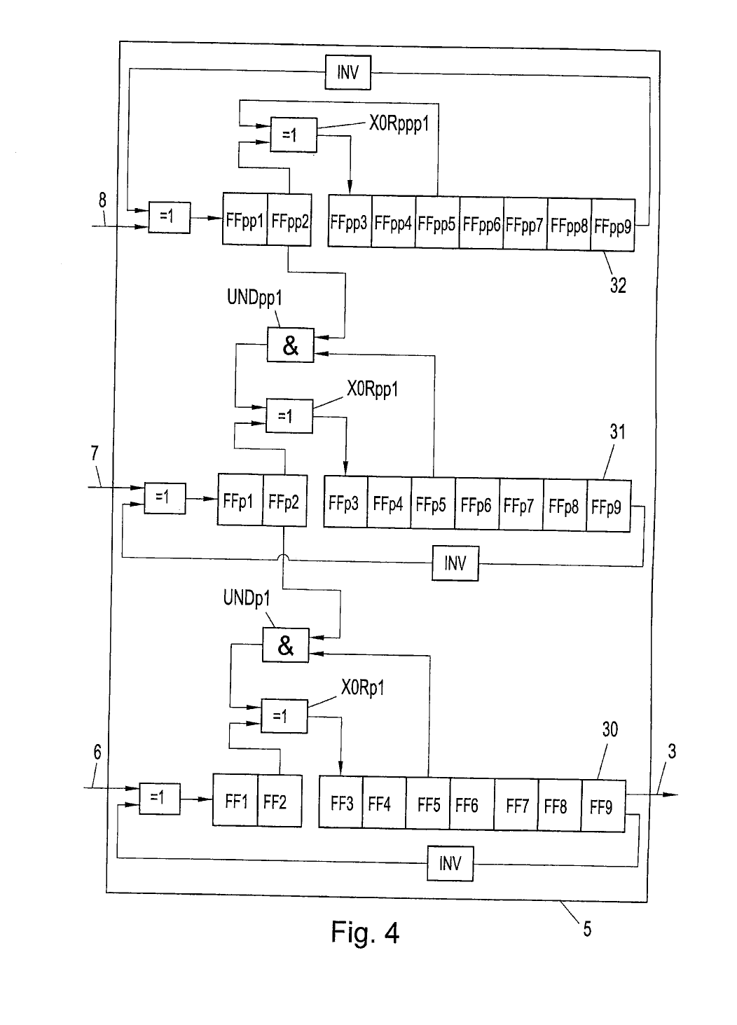

In the modified embodiment according to FIG. 4, a total of three shift registers 30, 31 and 32 are used. In this example each of the storage elements of the individual shift registers is connected recursively in the same manner as shown in FIG. 3. The shift registers are also connected to one another in such manner that the function of XOR gate XORp1 in the recursive connection of first shift register 30 is switched on and off depending on the state of second shift register 31. The function of XOR gate XORpp1 in the recursive connection of second shift register 31 is in turn switched on and off depending on the state of third shift register 32. For this purpose, the output of flip-flop FFp2 and accordingly FFpp2 of the one shift register 31 or 32 is connected to the input of an AND gate UNDp1 or UNDpp1, which is integrated in the respective recursive function XORp1 and XORpp1 of shift registers 30 and 31.

In this way, a code generator 5 with three levels is created, wherein the code generation is influenced at each level by initializing the respective shift register 30, 31 and 32 with bit sequences 6, 7 and 8. Initialization may preferably be effected in such manner that first bit sequence 6 is routed to shift register 30 of the first level, second bit sequence 7 is routed to shift register 31 of the second level, and third bit sequence 8 is routed to shift register 32 of the third level, wherein bit sequences 6, 7 and 8 are preferably defined as described in FIGS. 1 and 2.

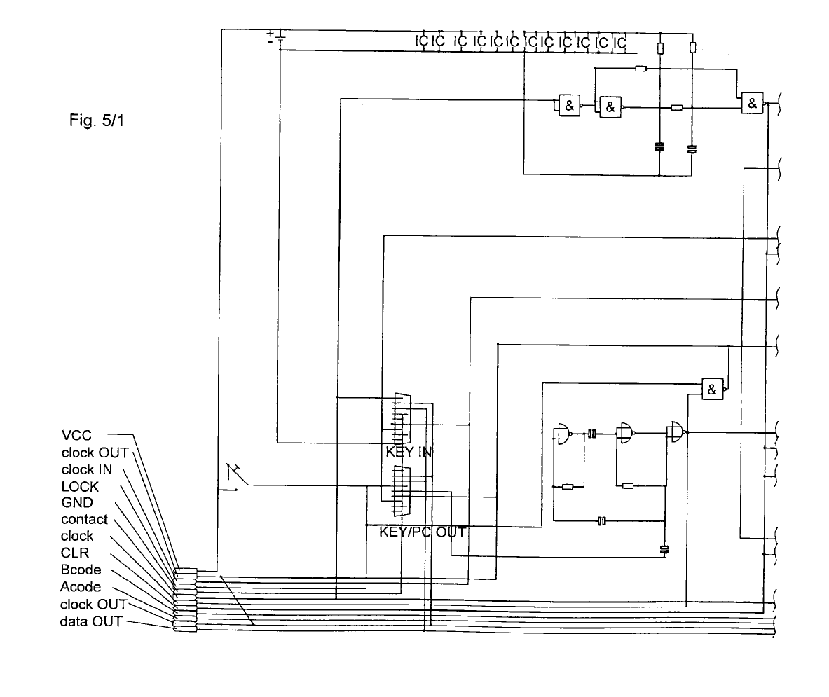

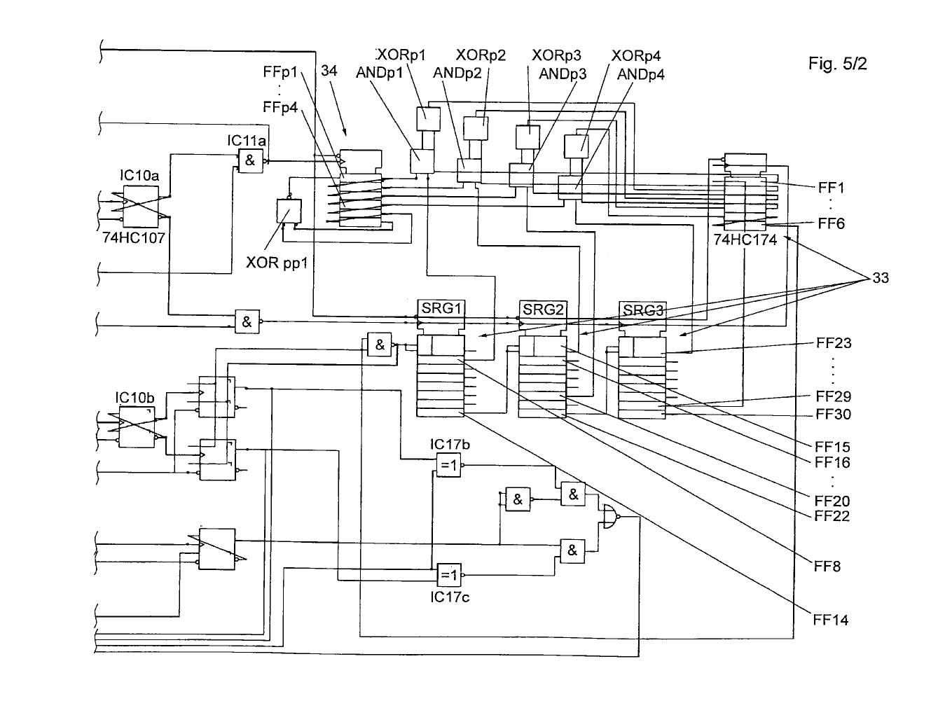

In the embodiment according to FIG. 5, the structure shown in FIG. 4 is designed to be yet more complex and in particular longer code producing rows and a plurality of recursive interconnections are provided. Here, a number of storage elements connected continuously in series are arranged in the form of shift registers SRG1, SRG2 . . . , which in functional terms together form a shift register 33 for the purposes of the invention. Thus the length of the code is doubled for each storage element added, and the length of the code may be calculated as follows

Lc=2ⁿ−1
(Lc=Length of the code sequence; n=Number of code-generating storage elements connected in series)

If this unit is operated at a certain speed, the following applies for the duration of the code:

$$Tc = \frac{{2}^{n} - 1}{fc}$$

(Tc=Period until the code is repeated; fc=Code generation clock frequency)

With fewer than 50 storage elements at a code generation clock speed of 384,000 bit/s, the code runs for longer than a year without the sequence being repeated, so that a signal to be encrypted can be sent in encrypted form over a dedicated line and decrypted simultaneously for an equally long period of time so that live transmissions are also possible for an equally long period of time.

Now if shift register 33 is long enough and XOR gates XORp1, p2, p3, p4 are inserted at multiple locations of said shift register 33 between one storage element FF1, 2, 3, 4 and the storage element FF2, 3, 4, 5 located next in the series, and this is then supplied with the signal from a third storage element FF8, 15, 20, 23, the code generated thereby can be modified in each case (FIG. 5).

In the case of a plurality of code changing XOR gates XORp1, p2, p3, p4, see FIG. 5, it should be ensured that the various code changing XOR gates XORp1, p2, p3, p4, the first inputs of which are supplied by an output from a storage element FF1, 2, 3, 4, each second input of which is supplied by the output from a storage element FF8, 15, 20, 23 that is at a distance downstream from first said storage element FF1, 2, 3, 4 by a number of storage elements, each of which corresponds to a different prime number that is greater than 1 but not an exact fraction of the total number of storage elements R connected in series, so that when the code sequence is modified no resonance effects are created that would shorten the code sequence. Accordingly, the corresponding storage element pairs FF1, 8; FF2, 15; FF3, 20, FF4, 23 are each separated by a number of 7, 13, 17 and 19 (prime numbers) storage elements.

If the output of an AND gate UNDp1 or UNDp1, p2, p3, p4, one input of which is attached to the output of storage element FF3 or FF8, 15, 20, 23, is connected to one of the two inputs of the respective XOR gate XORp1 or XORp1, p2, p3, p4, the code-changing effect of said XOR gate XORp1 or XORp1, p2, p3, p4 may be switched on or off via the second input of the AND gate UNDp1 or UNDp1, p2, p3, p4, and if a further storage element FFp1 or FFp1, p2, p3, p4 is connected to each, the switching on and off of the code-changing effect of XOR gate XORp1 or XORp1, 2, p3, p4 can be made programmable. The code-programming storage elements FFp1, p2, p3, p4 may be connected together to form a shift register 34. Subsequently, the code-programming storage elements FFp1, p2, p3, p4 of shift register 34 may themselves in turn be connected recursively using an XOR gate XORpp1.

The number of different programmable codes is calculated as follows:

Nc=2^{pn}−1
(Nc=Number of possible different codes; pn=Number of programmable XOR gates XORp1, p2, . . . pn)

Now if one is in possession of an identical code generator and wishes to predict the further code sequence on the basis of a certain number of bits, the probability of detecting the correct continuation of the code sequence is dependent not only on the number of storage elements FF1, 2, . . . n used in the code generation but also on the number of programmable, code-changing XOR gates XORp1, p2 . . . pn. It follows that the probability of discovering the programming on which the code is based and thus also being able to predict the subsequent code sequence is expressed with:

$$W = \frac{Nb}{( {2}^{n} - 1 ) * ( {2}^{pn} - 1 )}$$

(Nb=Number of observed bits of the code sequence; n=Number of code-generating, series-connected storage elements FF1, 2, . . . n; pn=Number of XOR gates XORp1, p2, . . . pn that can change the code by programmable means)

### EXAMPLE

233 is the 52^{nd} prime number. If 1 is not used and 233 expresses the total number of storage elements connected in series, there are 50 different storage elements on this segment, each of which is located at a distance from an output storage element that corresponds to a prime number (np=50). Since each recursive XOR gate 1-50 is connected in series between an adjacent storage element 1-50 starting with the first, the total length of the storage elements is increased to (n=233+50=283).

It follows that:

$$W = \frac{Nb}{( {2}^{n} - 1 ) * ( {2}^{pn} - 1 )} = \frac{Nb}{( {2}^{283} - 1 ) * ( {2}^{50} - 1 )}$$

$$W = \frac{Nb}{( 1 \text{,} 5541351138 * {10}^{85} - 1 ) * ( 1 \text{,} 125899068 * {10}^{15} - 1 )}$$

$$W \sim \frac{Nb}{1 \text{,} 7498005798 * {10}^{100}}$$

In other words, the code sequence must be observed for 1,7498005798*10¹⁰⁰ clock steps before the probability of discovering a given sequence reaches 1. If the clock frequency is 384000 Hz, this translates to a required observation time of 1,4449430312*10⁸⁷ years.

If the code-programming storage elements (FFp1, p2, p3, p4, p5, p6) of shift register 34 are interconnected recursively so that they cycle through all possible state combinations within the time interval

$$Tpn = \frac{{2}^{pn} - 1}{fp}$$

(T pn=Time to cycle through all possible programming states; pn=Number of program storage elements; fp=Programming clock frequency)

the programming is obtained from a given time interval in which the code-programming storage elements are supplied with a program clock time.

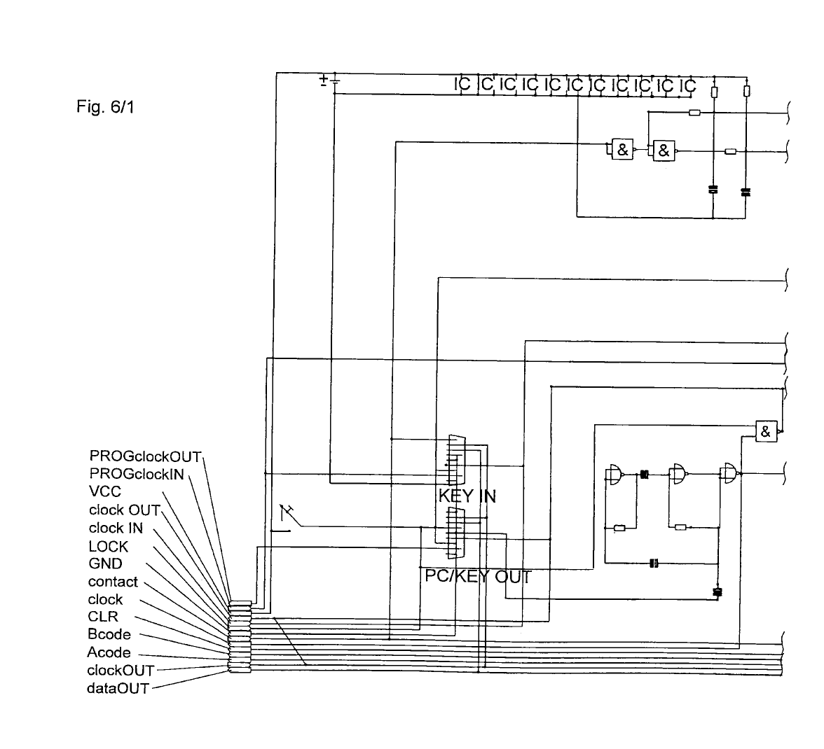

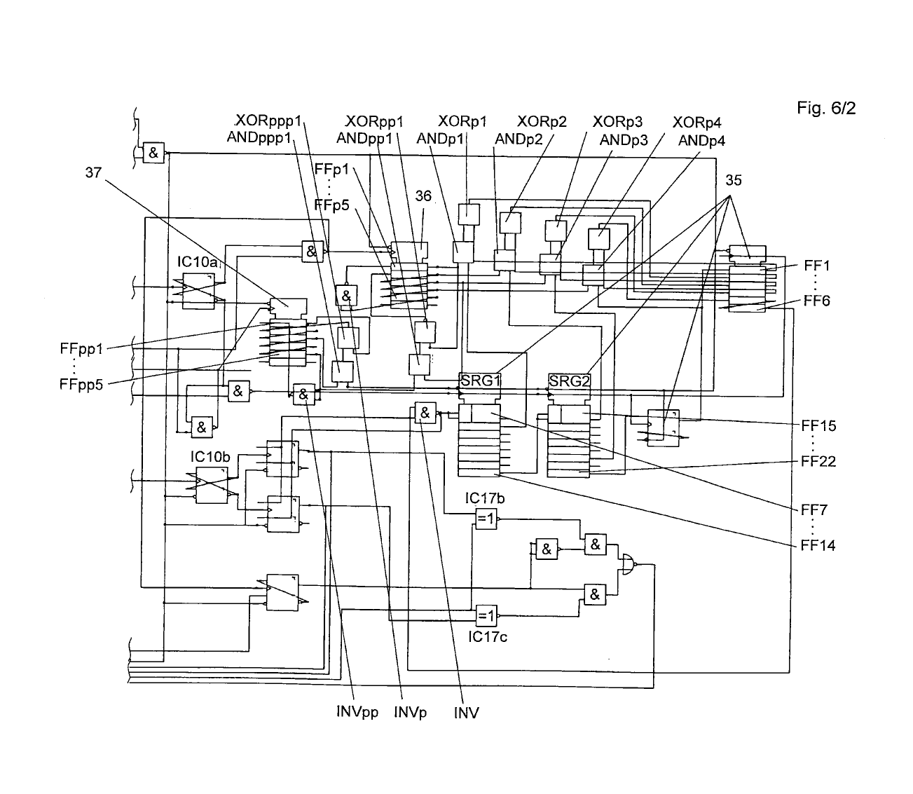

To guarantee that it is impossible to make even an approximate determination of the programming period, the programming may be carried out in two stages. For this purpose, an additional programming level can be added by connecting, and thus rendering programmable the code programming XOR gate XORpp1 itself, again interposing an AND gate UNDpp1 with a storage element series RRR, wherein again an XOR gate XORpppl is used for recursive connection of shift register 37 (FIG. 6).

Assuming the calculation example outlined in the preceding, it is thus guaranteed that the (2²⁸³−1)*(2⁵⁰−1) different states are divided up into 2⁵⁰−1 different sections, one of which is selected in the first programming phase. This selection process is performed in a maximum of 2^{ppn}−1 steps (ppn=number of prime numbers that are included in the number of primes used for programming (50) that is to say 16). This means that a maximum of 2¹⁶ steps must be carried out before all sections have been visited. With a programming clock frequency of 1 MHz, this operation is completed in 0.065 seconds. A period that may easily be spanned in any programming operation, since it is shorter than human response time, thereby guaranteeing that no conclusions may be drawn regarding the programming of the keys on the basis of actually elapsed programming time.

1-36. (canceled)

37. A method selected from the group consisting of:
(A) method selected from the group consisting of: method for performing symmetric stream encryption of data using a keystream and for transmission of encrypted data, wherein the keystream is generated using at least a first back coupled shift register and a second back coupled shift register, each of which is filled with a defined bit sequence for initialization thereof, wherein at least one XOR gate is used for back coupling each shift register and wherein the back coupled shift registers are connected to each other such that depending on the state of the one shift register the at least one XOR gate of the other shift register is switched on or off, characterized in that the data to be encrypted is distributed into data packets, each data packet is encrypted separately, wherein the back coupled shift registers are re-initialized for the encryption of each data packet, wherein the first back coupled shift register is initialized by filling with the first bit sequence and the second back coupled shift register is initialized by filling with the second bit sequence, wherein the first bit sequence is added to the respective encrypted data packet in plain text or in coded form, and the second bit sequence represents a secret key that is not added to the encrypted data packets, and the encrypted data packets are transmitted in packet switched manner together with the respective added bit sequence and optionally header data; and
(B) method for decrypting data that has been encrypted by symmetric stream encryption with the use of a keystream, wherein the keystream is generated using at least a first back coupled shift register and a second back coupled shift register, each of which is initialized by filling with a defined bit sequence, wherein at least one XOR gate is used to back couple each of the shift registers, and wherein the back coupled shift registers are connected to each other such that depending on the state of the one shift register the at least one XOR gate of the other shift register is switched on or off, characterized in that the data to be decrypted is received as data packets, each received data packet is decrypted separately, wherein the back coupled shift registers are re-initialized for the decryption of each data packet, wherein the first back coupled shift register is initialized by filling with the first bit sequence and the second back coupled shift register is initialized by filling with the second bit sequence, wherein the first bit sequence is read out in clear text or in coded form from the respective data packet to be decrypted, and the second bit sequence represents a secret key that cannot be read out from the data packets that are to be decrypted.

38. Method according to claim 37, characterized in that a bit sequence that is unique for the data packet to be encrypted is chosen as the first bit sequence, and is added in plain text or in coded form to each encrypted data packet as an identifier.

39. Method according to claim 37, characterized in that the second bit sequence is generated from a unique identifier of the transmitter and a unique identifier of the receiver.

40. Method according to claim 39, characterized in that the second bit sequence is generated by combining the unique identifier of the transmitter with the unique identifier of the receiver with the aid of an XOR function.

41. Method according to claim 37, characterized in that a third bit sequence is also used for initializing the one or more back coupled shift register(s).

42. Method according to claim 41, characterized in that the third bit sequence is generated from a current data and/or time indicator.

43. Method according to claim 41, characterized in that the third bit sequence is routed to a third back coupled shift register in order to initialize it.

44. Method according to claim 37, characterized in that the generation of the keystream begins as soon as at least one of the back coupled shift registers is filled with the first bit from the respective bit sequence.

45. Method according to claim 37, characterized in that the back coupled shift registers are filled with the respective bit sequence simultaneously.

46. Method according to claim 37, characterized in that the at least one back coupled shift register comprises a plurality of storage elements that are connected to form a code-producing series, wherein the output from the last storage element in the series is connected to the input of the first storage element in the series to form a closed loop, wherein back coupling is enabled with the aid of the at least one XOR gate in such manner that the first input of the XOR gate is connected to the output of a storage element located in the code-producing series, the second input is connected to the output of another storage element located in the code-producing series, and the output is connected to the input of the storage element immediately following the storage element connected to the first input of the XOR gate in the code-producing series.

47. Method according to claim 46, characterized in that an AND gate is installed in the line that connects the second input of the at least one XOR gate and the output of the further storage element located in the code-producing series in such manner that the output of the AND gate is connected to the second input of the XOR gate, the first input of the AND gate is connected to the output of the further storage element located in the code-producing series, and the second input of the AND gate is connected to the output of a code programming storage element, wherein a storage element of another back coupled shift register is used as the code-programming storage element, and that the output of a storage element located in the code-producing series is preferably connected to the input of an inverter and the output of the inverter is connected to the input of another storage element arranged in the code-producing series.

48. A device selected from the group consisting of:
(A) device for encrypting data with symmetric stream encryption using a keystream (3), particularly for carrying out the method according to any of claims 1 and 3 to 12, wherein at least one first and one second back coupled shift register (27; 30,31,32; 33,34; 35,36,37) that is/are initialized by filling with a defined bit sequence is/are provided for generating the keystream (3), wherein at least one XOR gate (XORp1, XORp2, XORp3, XORp4, XORpp1, XORppp1) is used to back couple each shift register (27; 30,31,32; 33,34; 35,36,37) and wherein the back coupled shift registers (30,31,32; 33,34; 35,36,37) are interconnected in such manner that depending on the state of the one shift register the at least one XOR gate (XORp1, XORp2, XORp3, XORp4, XORpp1) of the other shift register is switched on or off, characterized in that the data is distributed in data packets (1), that means (9, 10) are provided for generating and/or storing at least a first bit sequence (6) and a second bit sequence (7) and cooperate with the one or more shift register(s) (27; 30,31,32; 33,34; 35,36,37) in such a manner that the first bit sequence (6) is routed to the first back coupled shift register (30;33;35) to initialize it and the second bit sequence (7) is routed to the second back coupled shift register (31;34;36) to initialize it, wherein the back coupled shift register (27; 30,31,32; 33,34; 35,36,37) are re-initialized for encrypting each data packet (1), that data packet processing means (15) are provided, with which the means (9, 10) for generating and storing said first (6) and second (7) bit sequences cooperate in such a manner that the first bit sequence (6) is added to the respective encrypted data packet in clear text (17) or in coded form and the second bit sequence (7) represents a secret key that is not added to the encrypted data packets, and that data transmission means (19) are provided for packet-switched sending of the encrypted data packets together with the respective added bit sequence (17) and optionally header data (16; and
(B) device for decrypting data that has been encrypted with symmetric stream encryption using a keystream (3), particularly for carrying out the method according to any of claims 2 to 12, wherein at least a first and a second back coupled shift register (27; 30,31,32; 33,34; 35,36,37) are provided and initialized by filling with a defined bit sequence for generating the keystream (3), wherein at least one XOR gate (XORp1, XORp2, XORp3, XORp4, XORpp1, XORppp1) is used for back coupling each of the shift registers (27; 30,31,32; 33,34; 35,36,37) and wherein the back coupled shift registers (30,31,32; 33,34; 35,36,37) are interconnected in such manner that, depending on the state of the one shift register the at least one XOR gate (XORp1, XORp2, XORp3, XORp4, XORpp1) of the other shift register is switched on or off, characterized in that the encrypted data is distributed in data packets (1), that means (20) are provided for reading out a first bit sequence (6) from the data packets in plain text or in coded form, and means (24) are provided for generating and/or storing at least a second bit sequence (7), which means cooperate with the shift register (27; 30,31,32; 33,34; 35,36,37) in such manner that the first bit sequence (6) is routed to the first back coupled shift register (30;33;35) to initialize it and the second bit sequence (7) is routed to the second back coupled shift register (31;34;36) to initialize it, wherein the back coupled shift registers (27; 30,31,32; 33,34; 35,36,37) are re-initialized for decrypting each data packet, wherein the second bit sequence (7) represents a secret key that cannot be read out from the encrypted data packets.

49. Device according to claim 48, characterized in that the first bit sequence (6) is a bit sequence that is unique for the data packet (1) to be encrypted and is added to the respective encrypted data packet as a packet identifier (17) in clear text or in coded form.

50. Device according to claim 48, characterized in that means (13;25) are provided for generating the second bit sequence (7) from a unique identifier (11) of the transmitter and a unique identifier (12) of the receiver.

51. Device according to claim 50, characterized in that the means (13;25) for generating the second bit sequence (7) comprise an XOR gate, to one input of which the unique identifier (11) of the sender is routed and to the other input of which the unique identifier (12) of the receiver is routed.

52. Device according to claim 48, characterized in that means (14;26) are provided for generating and/or storing at least one third bit sequence (8), and which cooperate with the one or more shift register(s) (27;32;37) in such manner that the third bit sequence (8) is also used to initialize the one or more feedback shift register(s) (27; 32; 37).

53. Device according to claim 52, characterized in that the third bit sequence (8) is generated from a current date and/or time indicator.

54. Device according to claim 52, characterized in that the third bit sequence (8) is routed to a third back coupled shift register (32;37) to initialize it.

55. Device according to any of claims 48, characterized in that the generation of the keystream (3) begins as soon as at least one of the back coupled shift registers (27; 30,31,32; 33,34; 35,36,37) is filled with the first bit from the respective bit sequence.

56. Device according to claim 48, characterized in that the back coupled shift registers (30,31,32; 33,34; 35,36,37) are filled with the respective bit sequence simultaneously.

57. Device according to claim 48, characterized in that the at least one back coupled shift register (30,31,32; 33,34; 35,36,37) comprises a plurality of storage elements (FF1, FF2 , . . . ; FFp1, FFp2 , . . . ; FFpp1, FFpp2 , . . . ) that are connected to form a code-producing series, wherein the output of the last storage element in the series is connected to the input of the first storage element in the series to form a closed circuit, wherein back coupling is effected with the aid of the at least one XOR gate (XORp1, XORp2, XORp3, XORp4, XORpp1, XORppp1) in such manner that the first input of the XOR gate is connected to the output of a storage element (FF2) in the code-producing series, the second input is connected to the output of another storage element (FF5) in the code-producing series, and the output is connected to the input of the storage element (FF3) immediately after the storage element connected to the first input of the XOR gate in the code-producing series.

58. Device according to claim 57, characterized in that an AND gate (UNDp1) is installed in the line that connects the second input of the at least one XOR gate (XORp1) and the output of the further storage element (FF5) located in the code-producing series (30;33;35) in such manner that the output of the AND gate (UNDp1) is connected to the second input of the XOR gate (XORp1), the first input of the AND gate (UNDp1) is connected to the output of the further storage element (FF5) located in the code-producing series (30;33;35), and the second input of the AND gate (UNDp1) is connected to the output of a code programming storage element (FFp2), and that the output of a storage element (FF9) located in the code-producing series (30;33;35) is preferably connected to the input of an inverter (INV) and the output of the inverter (INV) is connected to the input of another storage element (FF1) arranged in the code-producing series (30;33;35), wherein a storage element of a further back coupled shift register (31;34;36) is used as a code-programming storage element.

59. Device according to claim 57, characterized in that a plurality of XOR gates (XORp1,p2,p3,p4) is provided, the first input of each of which is supplied from an output of a storage element (FF1,2,3,4) located in the code-producing series (30;33;35), and the second input of each of which is supplied from the output of a further storage element (FF8,15,20,23) located in the code-producing series (30;33;35), which is located at a distance downstream in the series (30;33;35) from the respective storage element (FF1, 2,3,4) by a number of storage elements, each of which corresponds to a different prime number that is greater than 1 but not an exact fraction of the total number of storage elements (FF1,2, . . . n) connected in series (30;33;35).

60. Device according to claim 57, characterized in that a plurality of code-programming storage elements (FFp1,p2,p3,p4, . . . pn), are provided and are each assigned to an AND gate (UNDp1,p2,p3,p4) and an XOR gate (XORp1,p2,p3,p4) and are connected in a series (31;34;36) that forms a closed loop, and at least one XOR gate (XORpp1) is arranged, the first input of which is connected to the output of a storage element (FFp6) located in the code-programming series (31;34;36), the second input of which is connected to the output of a further storage element (FFp5) located in the code-programming series (31;34;36), and the output of which is connected to the input of the storage element (FFp1) in the code-programming series (31;34;36) following the storage element (FFp6) that is connected to the first input of the XOR gate (XORpp1).

61. Device according to claim 57, characterized in that an AND gate (UNDpp1) is installed in the line that connects the second input of the at least one XOR gate (XORpp1) and the output of the further storage element (FFp3) located in the code-programming series (31;34;36) in such manner that the output of the AND gate (UNDpp1) is connected to the second input of the XOR gate (XORpp1), the first input of the AND gate (UNDpp1) is connected to the output of the further storage element (FFp3) located in the code-programming series (31;34;36), and the second input of the AND gate (UNDpp1) is connected to the output of a storage element (FFpp5) that is used for programming the code-programming series (31;34;36).

62. Device according to claim 57, characterized in that a plurality of storage elements (FFpp1,pp2,pp3,pp4, . . . ppn) are provided and are used for programming the code-programming series (31;34;36), each being assigned to an AND gate (UNDpp1) and an XOR gate (XORpp1), and are connected in a series (32;37) that forms a closed loop, and at least one XOR gate (XORppp1) is arranged, the first input of which is connected to the output of a storage element (FFpp1) located in the series (32;37), the second input of which is connected to the output of a further storage element (FFpp3) located in the series (32;37), and the output of which is connected to the input of the storage element (FFpp2) in the series (32;37) immediately following the storage element (FFpp1) that is connected to the first input of the XOR gate (XORppp1).
